(19) United States
(12) Patent Application Publication
(10) Pub. No.: US 2026/0172571 A1
(43) Pub. Date: Jun. 18, 2026

(54) VIDEO CODING METHOD AND DEVICE USING AFFINE MODEL-BASED PREDICTION

(71) Applicants: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(72) Inventors: Dong Gyu SIM, Seoul (KR); Sea Nae PARK, Seoul (KR); Min Hun LEE, Uijeongbu-si, Gyeonggi-do (KR); Jin HEO, Yongin-si, Gyeonggi-do (KR); Seung Wook PARK, Yongin-si, Gyeonggi-do (KR)

(73) Assignees: Hyundai Motor Company, Seoul (KR); Kia Corporation, Seoul (KR); KWANGWOON UNIVERSITY INDUSTRY-ACADEMIC COLLABORATION FOUNDATION, Seoul (KR)

(21) Appl. No.: 19/125,122

(22) PCT Filed: Oct. 16, 2023
(86) PCT No.: PCT/KR2023/015951

§ 371 Date: Apr. 28, 2025

(30) Foreign Application Priority Data
Nov. 29, 2022 (KR) 10-2022-0162308
Oct. 11, 2023 (KR) 10-2023-0135316

(51) Int. Cl. H04N 19/137; H04N 19/176

(52) U.S. Cl. CPC H04N 19/137; H04N 19/176

(57) ABSTRACT

A method and an apparatus are disclosed for video coding using an affine model-based prediction. In the disclosed embodiments, a video decoding device decodes, from a bitstream, all or part of affine model information, control point motion vector information, and a reference picture index. The video decoding device determines the form of the affine model based on the affine model information, and derives control point motion vectors based on the affine model and the control point motion vector information. The video decoding device generates a motion vector for each prediction unit of the current block by using the control point motion vectors, and generates a prediction block of the current block by generating prediction values for each prediction unit of the current block by using the motion vector and a reference picture indicated by the reference picture index.

### TECHNICAL FIELD

The present disclosure relates to a video coding method and an apparatus using an affine model-based prediction.

### BACKGROUND

The statements in this section merely provide background information related to the present disclosure and do not necessarily constitute prior art.

Since video data has a large amount of data compared to audio or still image data, the video data requires a lot of hardware resources, including a memory, to store or transmit the video data without processing for compression.

Accordingly, an encoder is generally used to compress and store or transmit video data. A decoder receives the compressed video data, decompresses the received compressed video data, and plays the decompressed video data. Video compression techniques include H.264/Advanced Video Coding (AVC), High Efficiency Video Coding (HEVC), and Versatile Video Coding (VVC), which has improved coding efficiency by about 30% or more compared to HEVC.

However, since the image size, resolution, and frame rate gradually increase, the amount of data to be encoded also increases. Accordingly, a new compression technique providing higher coding efficiency and an improved image enhancement effect than existing compression techniques is required.

As a method of improving encoding/decoding efficiency, an affine model deals with a changed object signal or a changed background signal in a video after following the movement of a camera or an object in space and time to derive a geometric relationship between the object or background signal and the camera or object, modeling the relationship, and applying the modeled relationship to a reference signal and an original signal. In theory, if a relationship is perfectly derived to represent a three-dimensional affine model of the same object, a perfect prediction can be made using that relationship. However, such a perfect prediction is only attainable in theory. In video coding, prediction errors can be compensated by using a prediction signal predicted based on the modeling and using a difference signal. The affine model-based prediction method has the effect that prediction accuracy can bring improved coding efficiency, but it suffers from increasing the computational complexity for the calculation of the affine model. Therefore, to increase video coding efficiency and enhance video quality, there is a need for a method of reducing the computational complexity and effectively transmitting related encoding information when performing the calculation of the affine model.

### DISCLOSURE

### Technical Problem

The present disclosure seeks to provide a video coding method and an apparatus that, when performing an affine model-based prediction of a current block, effectively transmit information about the affine model.

### Technical Solution

At least one aspect of the present disclosure provides a method of decoding a current block by a video decoding apparatus. The method includes decoding, from a bitstream, all or part of affine model information, control point motion vector information, and a reference picture index. The affine model information indicates a form of an affine model, and the control point motion vector information includes a prediction method for control point motion vectors and control point motion vector differences. The method also includes determining the form of the affine model based on the affine model information. The method also includes deriving control point motion vectors based on the affine model and the control point motion vector information. The method also includes generating a motion vector for each prediction unit of the current block by using the control point motion vectors. The method also includes generating a prediction block of the current block by generating prediction values for each prediction unit of the current block by using the motion vector and a reference picture indicated by the reference picture index. In decoding the control point motion vector information, the method includes deriving, at an overlapping vertex between a reconstructed block and the current block, a control point motion vector at the overlapping vertex in the current block by using a control point motion vector at the overlapping vertex in the reconstructed block.

Another aspect of the present disclosure provides a method of encoding a current block by a video encoding apparatus. The method includes determining affine model information and a prediction method for control point motion vectors. The affine model information indicates a form of an affine model. The method also includes determining the form of the affine model based on the affine model information. The method includes deriving control point motion vectors based on the affine model. The method also includes generating a motion vector for each prediction unit of the current block by using the control point motion vectors. The method also includes generating a first prediction block of the current block by generating prediction values for each prediction unit by using the motion vector and a reference picture. The method also includes deriving control point motion vector predictors according to the affine model and the prediction method for the control point motion vectors, and generating a control point motion vector difference by subtracting each of the control point motion vector predictors from each of the control point motion vectors. The method also includes encoding the affine model information, the index indicative of the reference picture, the prediction method for the control point motion vectors, and control point motion vector differences. In generating the control point motion vector difference, the method includes deriving, at an overlapping vertex between an encoded block and the current block, a control point motion vector at the overlapping vertex in the current block by using a control point motion vector at the overlapping vertex in the encoded block.

Yet another aspect of the present disclosure provides a computer-readable recording medium storing a bitstream generated by a video encoding method. The video encoding method includes determining an affine model information and a prediction method for control point motion vectors. The affine model information indicates a form of an affine model. The video encoding method also includes determining the form of the affine model based on the affine model information. The video encoding method also includes deriving control point motion vectors based on the affine model. The video encoding method also includes generating a motion vector for each prediction unit of a current block by using the control point motion vectors. The video encoding method also includes generating a first prediction block of the current block by generating prediction values for each prediction unit by using the motion vector and a reference picture. The video encoding method also includes deriving control point motion vector predictors according to the affine model and the prediction method for the control point motion vector, and generating a control point motion vector difference by subtracting each of the control point motion vector predictors from each of the control point motion vectors. The video encoding method also includes encoding the affine model information, the index indicative of the reference picture, the prediction method for the control point motion vectors, and control point motion vector differences. In generating the control point motion vector difference, the video encoding method includes deriving, at an overlapping vertex between an encoded block and the current block, a control point motion vector at the overlapping vertex in the current block by using a control point motion vector at the overlapping vertex in the encoded block.

### Advantageous Effects

As described above, the present disclosure provides a video coding method and an apparatus that, when performing an affine model-based prediction of a current block, effectively transmit information about the affine model. Thus, the video coding method and the apparatus increase video coding efficiency and enhance video quality.

### BRIEF DESCRIPTION OF THE DRAWINGS

FIG. 1 is a block diagram of a video encoding apparatus that may implement the techniques of the present disclosure.

FIG. 2 illustrates a method for partitioning a block using a quadtree plus binarytree ternarytree (QTBTTT) structure.

FIGS. 3A and 3B illustrate a plurality of intra prediction modes including wide-angle intra prediction modes.

FIG. 4 illustrates neighboring blocks of a current block.

FIG. 5 is a block diagram of a video decoding apparatus that may implement the techniques of the present disclosure.

FIG. 6 is a diagram illustrating the pixel-wise calculation of an affine model, according to at least one embodiment of the present disclosure.

FIG. 7 is a diagram illustrating the affine model calculation using a center vector, according to at least one embodiment of the present disclosure.

FIG. 8 is a diagram illustrating the subblock-wise computation of an affine model, according to at least one embodiment of the present disclosure.

FIG. 9 is a diagram illustrating a portion of a video decoding apparatus for affine model-based prediction according to at least one embodiment of the present disclosure.

FIGS. 10A to 10D are diagrams illustrating motion vectors of subblock units according to at least one embodiment of the present disclosure.

FIGS. 11A to 11C are diagrams illustrating a derivation of an overlapping control point motion vector according to at least one embodiment of the present disclosure.

FIGS. 12A and 12B are a flowchart of a method of encoding a current block by a video encoding apparatus, according to at least one embodiment of the present disclosure.

FIG. 13 is a flowchart of a method of reconstructing a current block by a video decoding apparatus, according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions when considered to obscure the subject of the present disclosure may be omitted for the purpose of clarity and for brevity.

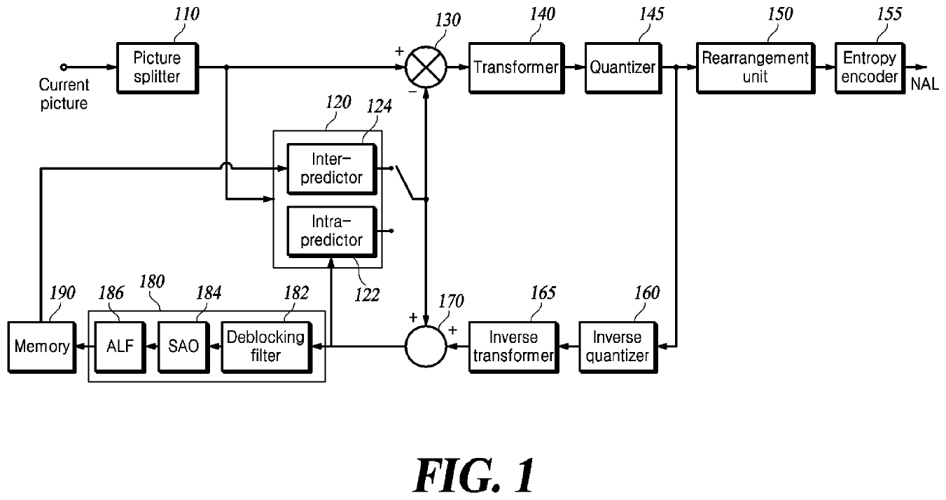

FIG. 1 is a block diagram of a video encoding apparatus that may implement technologies of the present disclosure. Hereinafter, referring to illustration of FIG. 1, the video encoding apparatus and components of the apparatus are described.

The encoding apparatus may include a picture splitter 110, a predictor 120, a subtractor 130, a transformer 140, a quantizer 145, a rearrangement unit 150, an entropy encoder 155, an inverse quantizer 160, an inverse transformer 165, an adder 170, a loop filter unit 180, and a memory 190.

Each component of the encoding apparatus may be implemented as hardware or software or implemented as a combination of hardware and software. Further, a function of each component may be implemented as software, and a microprocessor may also be implemented to execute the function of the software corresponding to each component.

One video is constituted by one or more sequences including a plurality of pictures. Each picture is split into a plurality of areas, and encoding is performed for each area. For example, one picture is split into one or more tiles or/and slices. Here, one or more tiles may be defined as a tile group. Each tile or/and slice is split into one or more coding tree units (CTUs). In addition, each CTU is split into one or more coding units (CUs) by a tree structure. Information applied to each coding unit (CU) is encoded as a syntax of the CU, and information commonly applied to the CUs included in one CTU is encoded as the syntax of the CTU. Further, information commonly applied to all blocks in one slice is encoded as the syntax of a slice header, and information applied to all blocks constituting one or more pictures is encoded to a picture parameter set (PPS) or a picture header. Furthermore, information, which the plurality of pictures commonly refers to, is encoded to a sequence parameter set (SPS). In addition, information, which one or more SPS commonly refer to, is encoded to a video parameter set (VPS). Further, information commonly applied to one tile or tile group may also be encoded as the syntax of a tile or tile group header. The syntaxes included in the SPS, the PPS, the slice header, the tile, or the tile group header may be referred to as a high level syntax.

The picture splitter 110 determines a size of a coding tree unit (CTU). Information on the size of the CTU (CTU size) is encoded as the syntax of the SPS or the PPS and delivered to a video decoding apparatus.

The picture splitter 110 splits each picture constituting the video into a plurality of coding tree units (CTUs) having a predetermined size and then recursively splits the CTU by using a tree structure. A leaf node in the tree structure becomes the coding unit (CU), which is a basic unit of encoding.

The tree structure may be a quadtree (QT) in which a higher node (or a parent node) is split into four lower nodes (or child nodes) having the same size. The tree structure may also be a binarytree (BT) in which the higher node is split into two lower nodes. The tree structure may also be a temarytree (TT) in which the higher node is split into three lower nodes at a ratio of 1:2:1. The tree structure may also be a structure in which two or more structures among the QT structure, the BT structure, and the TT structure are mixed. For example, a quadtree plus binarytree (QTBT) structure may be used or a quadtree plus binarytree temarytree (QTBTTT) structure may be used. Here, a binarytree temarytree (BTTT) is added to the tree structures to be referred to as a multiple-type tree (MTT).

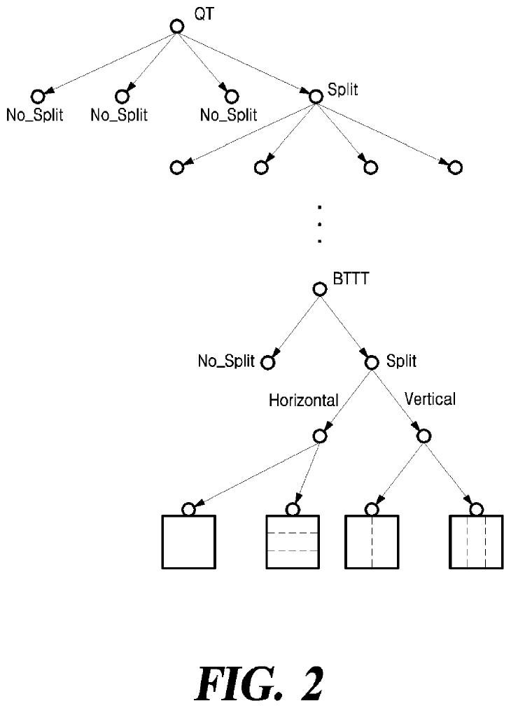

FIG. 2 is a diagram for describing a method for splitting a block by using a QTBTTT structure.

As illustrated in FIG. 2, the CTU may first be split into the QT structure. Quadtree splitting may be recursive until the size of a splitting block reaches a minimum block size (MinQTSize) of the leaf node permitted in the QT. A first flag (QT_split_flag) indicating whether each node of the QT structure is split into four nodes of a lower layer is encoded by the entropy encoder 155 and signaled to the video decoding apparatus. When the leaf node of the QT is not larger than a maximum block size (MaxBTSize) of a root node permitted in the BT, the leaf node may be further split into at least one of the BT structure or the TT structure. A plurality of split directions may be present in the BT structure and/or the TT structure. For example, there may be two directions, i.e., a direction in which the block of the corresponding node is split horizontally and a direction in which the block of the corresponding node is split vertically. As illustrated in FIG. 2, when the MTT splitting starts, a second flag (mtt_split_flag) indicating whether the nodes are split, and a flag additionally indicating the split direction (vertical or horizontal), and/or a flag indicating a split type (binary or ternary) if the nodes are split are encoded by the entropy encoder 155 and signaled to the video decoding apparatus.

Alternatively, prior to encoding the first flag (QT_split_flag) indicating whether each node is split into four nodes of the lower layer, a CU split flag (split_cu_flag) indicating whether the node is split may also be encoded. When a value of the CU split flag (split_cu_flag) indicates that each node is not split, the block of the corresponding node becomes the leaf node in the split tree structure and becomes the CU, which is the basic unit of encoding. When the value of the CU split flag (split_cu_flag) indicates that each node is split, the video encoding apparatus starts encoding the first flag first by the above-described scheme.

When the QTBT is used as another example of the tree structure, there may be two types, i.e., a type (i.e., symmetric horizontal splitting) in which the block of the corresponding node is horizontally split into two blocks having the same size and a type (i.e., symmetric vertical splitting) in which the block of the corresponding node is vertically split into two blocks having the same size. A split flag (split_flag) indicating whether each node of the BT structure is split into the block of the lower layer and split type information indicating a splitting type are encoded by the entropy encoder 155 and delivered to the video decoding apparatus. Meanwhile, a type in which the block of the corresponding node is split into two blocks asymmetrical to each other may be additionally present. The asymmetrical form may include a form in which the block of the corresponding node is split into two rectangular blocks having a size ratio of 1:3 or may also include a form in which the block of the corresponding node is split in a diagonal direction.

The CU may have various sizes according to QTBT or QTBTTT splitting from the CTU. Hereinafter, a block corresponding to a CU (i.e., the leaf node of the QTBTTT) to be encoded or decoded is referred to as a “current block.” As the QTBTTT splitting is adopted, a shape of the current block may also be a rectangular shape in addition to a square shape.

The predictor 120 predicts the current block to generate a prediction block. The predictor 120 includes an intra predictor 122 and an inter predictor 124.

In general, each of the current blocks in the picture may be predictively coded. In general, the prediction of the current block may be performed by using an intra prediction technology (using data from the picture including the current block) or an inter prediction technology (using data from a picture coded before the picture including the current block). The inter prediction includes both unidirectional prediction and bidirectional prediction.

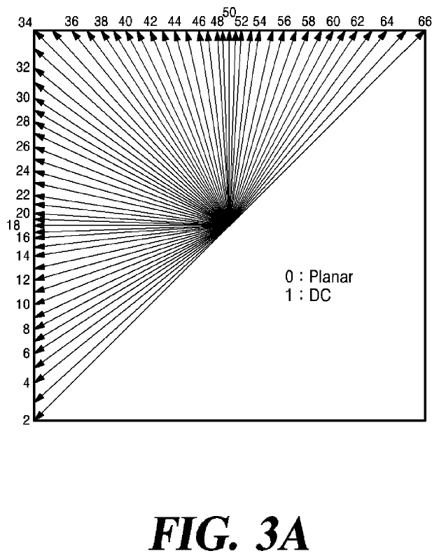

The intra predictor 122 predicts pixels in the current block by using pixels (reference pixels) positioned on a neighbor of the current block in the current picture including the current block. There is a plurality of intra prediction modes according to the prediction direction. For example, as illustrated in FIG. 3A, the plurality of intra prediction modes may include 2 non-directional modes including a Planar mode and a DC mode and may include 65 directional modes. A neighboring pixel and an arithmetic equation to be used are defined differently according to each prediction mode.

For efficient directional prediction for the current block having a rectangular shape, directional modes (#67 to #80, intra prediction modes #−1 to #−14) illustrated as dotted arrows in FIG. 3B may be additionally used. The directional modes may be referred to as “wide angle intra-prediction modes”. In FIG. 3B, the arrows indicate corresponding reference samples used for the prediction and do not represent the prediction directions. The prediction direction is opposite to a direction indicated by the arrow. When the current block has the rectangular shape, the wide angle intra-prediction modes are modes in which the prediction is performed in an opposite direction to a specific directional mode without additional bit transmission. In this case, among the wide angle intra-prediction modes, some wide angle intra-prediction modes usable for the current block may be determined by a ratio of a width and a height of the current block having the rectangular shape. For example, when the current block has a rectangular shape in which the height is smaller than the width, wide angle intra-prediction modes (intra prediction modes #67 to #80) having an angle smaller than 45 degrees are usable. When the current block has a rectangular shape in which the width is larger than the height, the wide angle intra-prediction modes having an angle larger than −135 degrees are usable.

The intra predictor 122 may determine an intra prediction to be used for encoding the current block. In some examples, the intra predictor 122 may encode the current block by using multiple intra prediction modes and may also select an appropriate intra prediction mode to be used from tested modes. For example, the intra predictor 122 may calculate rate-distortion values by using a rate-distortion analysis for multiple tested intra prediction modes and may also select an intra prediction mode having best rate-distortion features among the tested modes.

The intra predictor 122 selects one intra prediction mode among a plurality of intra prediction modes and predicts the current block by using a neighboring pixel (reference pixel) and an arithmetic equation determined according to the selected intra prediction mode. Information on the selected intra prediction mode is encoded by the entropy encoder 155 and delivered to the video decoding apparatus.

The inter predictor 124 generates the prediction block for the current block by using a motion compensation process. The inter predictor 124 searches a block most similar to the current block in a reference picture encoded and decoded earlier than the current picture and generates the prediction block for the current block by using the searched block. In addition, a motion vector (MV) is generated, which corresponds to a displacement between the current block in the current picture and the prediction block in the reference picture. In general, motion estimation is performed for a luma component, and a motion vector calculated based on the luma component is used for both the luma component and a chroma component. Motion information including information on the reference picture and information on the motion vector used for predicting the current block is encoded by the entropy encoder 155 and delivered to the video decoding apparatus.

The inter predictor 124 may also perform interpolation for the reference picture or a reference block in order to increase accuracy of the prediction. In other words, sub-samples between two contiguous integer samples are interpolated by applying filter coefficients to a plurality of contiguous integer samples including two integer samples. When a process of searching a block most similar to the current block is performed for the interpolated reference picture, not integer sample unit precision but decimal unit precision may be expressed for the motion vector. Precision or resolution of the motion vector may be set differently for each target area to be encoded, e.g., a unit such as the slice, the tile, the CTU, the CU, and the like. When such an adaptive motion vector resolution (AMVR) is applied, information on the motion vector resolution to be applied to each target area should be signaled for each target area. For example, when the target area is the CU, the information on the motion vector resolution applied for each CU is signaled. The information on the motion vector resolution may be information representing precision of a motion vector difference to be described below.

Meanwhile, the inter predictor 124 may perform inter prediction by using bi-prediction. In the case of bi-prediction, two reference pictures and two motion vectors representing a block position most similar to the current block in each reference picture are used. The inter predictor 124 selects a first reference picture and a second reference picture from reference picture list 0 (RefPicList0) and reference picture list 1 (RefPicList1), respectively. The inter predictor 124 also searches blocks most similar to the current blocks in the respective reference pictures to generate a first reference block and a second reference block. In addition, the prediction block for the current block is generated by averaging or weighted-averaging the first reference block and the second reference block. In addition, motion information including information on two reference pictures used for predicting the current block and including information on two motion vectors is delivered to the entropy encoder 155. Here, reference picture list 0 may be constituted by pictures before the current picture in a display order among pre-reconstructed pictures, and reference picture list 1 may be constituted by pictures after the current picture in the display order among the pre-reconstructed pictures. However, although not particularly limited thereto, the pre-reconstructed pictures after the current picture in the display order may be additionally included in reference picture list 0. Inversely, the pre-reconstructed pictures before the current picture may also be additionally included in reference picture list 1.

In order to minimize a bit quantity consumed for encoding the motion information, various methods may be used.

For example, when the reference picture and the motion vector of the current block are the same as the reference picture and the motion vector of the neighboring block, information capable of identifying the neighboring block is encoded to deliver the motion information of the current block to the video decoding apparatus. Such a method is referred to as a merge mode.

In the merge mode, the inter predictor 124 selects a predetermined number of merge candidate blocks (hereinafter, referred to as a “merge candidate”) from the neighboring blocks of the current block.

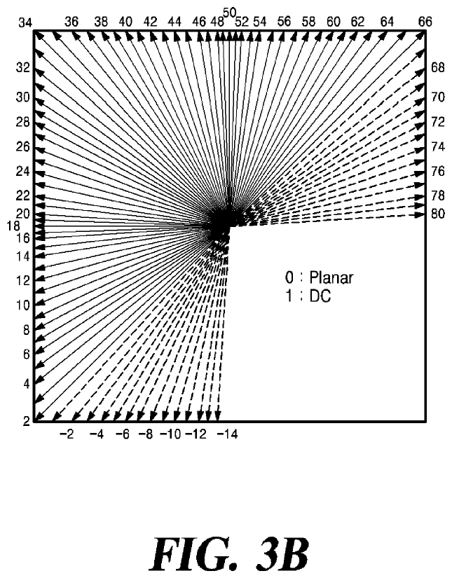

As a neighboring block for deriving the merge candidate, all or some of a left block A0, a bottom left block A1, a top block B0, a top right block B1, and a top left block B2 adjacent to the current block in the current picture may be used as illustrated in FIG. 4. Further, a block positioned within the reference picture (may be the same as or different from the reference picture used for predicting the current block) other than the current picture at which the current block is positioned may also be used as the merge candidate. For example, a co-located block with the current block within the reference picture or blocks adjacent to the co-located block may be additionally used as the merge candidate. If the number of merge candidates selected by the method described above is smaller than a preset number, a zero vector is added to the merge candidate.

The inter predictor 124 configures a merge list including a predetermined number of merge candidates by using the neighboring blocks. A merge candidate to be used as the motion information of the current block is selected from the merge candidates included in the merge list, and merge index information for identifying the selected candidate is generated. The generated merge index information is encoded by the entropy encoder 155 and delivered to the video decoding apparatus.

A merge skip mode is a special case of the merge mode. After quantization, when all transform coefficients for entropy encoding are close to zero, only the neighboring block selection information is transmitted without transmitting residual signals. By using the merge skip mode, it is possible to achieve a relatively high encoding efficiency for images with slight motion, still images, screen content images, and the like.

Hereafter, the merge mode and the merge skip mode are collectively referred to as the merge/skip mode.

Another method for encoding the motion information is an advanced motion vector prediction (AMVP) mode.

In the AMVP mode, the inter predictor 124 derives motion vector predictor candidates for the motion vector of the current block by using the neighboring blocks of the current block. As a neighboring block used for deriving the motion vector predictor candidates, all or some of a left block A0, a bottom left block A1, a top block B0, a top right block B1, and a top left block B2 adjacent to the current block in the current picture illustrated in FIG. 4 may be used. Further, a block positioned within the reference picture (may be the same as or different from the reference picture used for predicting the current block) other than the current picture at which the current block is positioned may also be used as the neighboring block used for deriving the motion vector predictor candidates. For example, a co-located block with the current block within the reference picture or blocks adjacent to the co-located block may be used. If the number of motion vector candidates selected by the method described above is smaller than a preset number, a zero vector is added to the motion vector candidate.

The inter predictor 124 derives the motion vector predictor candidates by using the motion vector of the neighboring blocks and determines motion vector predictor for the motion vector of the current block by using the motion vector predictor candidates. In addition, a motion vector difference is calculated by subtracting motion vector predictor from the motion vector of the current block.

The motion vector predictor may be acquired by applying a pre-defined function (e.g., center value and average value computation, and the like) to the motion vector predictor candidates. In this case, the video decoding apparatus also knows the pre-defined function. Further, since the neighboring block used for deriving the motion vector predictor candidate is a block in which encoding and decoding are already completed, the video decoding apparatus may also already know the motion vector of the neighboring block. Therefore, the video encoding apparatus does not need to encode information for identifying the motion vector predictor candidate. Accordingly, in this case, information on the motion vector difference and information on the reference picture used for predicting the current block are encoded.

Meanwhile, the motion vector predictor may also be determined by a scheme of selecting any one of the motion vector predictor candidates. In this case, information for identifying the selected motion vector predictor candidate is additional encoded jointly with the information on the motion vector difference and the information on the reference picture used for predicting the current block.

The subtractor 130 generates a residual block by subtracting the prediction block generated by the intra predictor 122 or the inter predictor 124 from the current block.

The transformer 140 transforms residual signals in a residual block having pixel values of a spatial domain into transform coefficients of a frequency domain. The transformer 140 may transform residual signals in the residual block by using a total size of the residual block as a transform unit or also split the residual block into a plurality of subblocks and may perform the transform by using the subblock as the transform unit. Alternatively, the residual block is divided into two subblocks, which are a transform area and a non-transform area, to transform the residual signals by using only the transform area subblock as the transform unit. Here, the transform area subblock may be one of two rectangular blocks having a size ratio of 1:1 based on a horizontal axis (or vertical axis). In this case, a flag (cu_sbt_flag) indicates that only the subblock is transformed, and directional (vertical/horizontal) information (cu_sbt_horizontal_flag) and/or positional information (cu_sbt_pos_flag) are encoded by the entropy encoder 155 and signaled to the video decoding apparatus. Further, a size of the transform area subblock may have a size ratio of 1:3 based on the horizontal axis (or vertical axis). In this case, a flag (cu_sbt_quad_flag) dividing the corresponding splitting is additionally encoded by the entropy encoder 155 and signaled to the video decoding apparatus.

Meanwhile, the transformer 140 may perform the transform for the residual block individually in a horizontal direction and a vertical direction. For the transform, various types of transform functions or transform matrices may be used. For example, a pair of transform functions for horizontal transform and vertical transform may be defined as a multiple transform set (MTS). The transformer 140 may select one transform function pair having highest transform efficiency in the MTS and may transform the residual block in each of the horizontal and vertical directions. Information (mts_idx) on the transform function pair in the MTS is encoded by the entropy encoder 155 and signaled to the video decoding apparatus.

The quantizer 145 quantizes the transform coefficients output from the transformer 140 using a quantization parameter and outputs the quantized transform coefficients to the entropy encoder 155. The quantizer 145 may also immediately quantize the related residual block without the transform for any block or frame. The quantizer 145 may also apply different quantization coefficients (scaling values) according to positions of the transform coefficients in the transform block. A quantization matrix applied to quantized transform coefficients arranged in 2 dimensional may be encoded and signaled to the video decoding apparatus.

The rearrangement unit 150 may perform realignment of coefficient values for quantized residual values.

The rearrangement unit 150 may change a 2D coefficient array to a 1D coefficient sequence by using coefficient scanning. For example, the rearrangement unit 150 may output the 1D coefficient sequence by scanning a DC coefficient to a high-frequency domain coefficient by using a zig-zag scan or a diagonal scan. According to the size of the transform unit and the intra prediction mode, vertical scan of scanning a 2D coefficient array in a column direction and horizontal scan of scanning a 2D block type coefficient in a row direction may also be used instead of the zig-zag scan. In other words, according to the size of the transform unit and the intra prediction mode, a scan method to be used may be determined among the zig-zag scan, the diagonal scan, the vertical scan, and the horizontal scan.

The entropy encoder 155 generates a bitstream by encoding a sequence of 1D quantized transform coefficients output from the rearrangement unit 150 by using various encoding schemes including a Context-based Adaptive Binary Arithmetic Code (CABAC), an Exponential Golomb, or the like.

Further, the entropy encoder 155 encodes information, such as a CTU size, a CTU split flag, a QT split flag, an MTT split type, an MTT split direction, etc., related to the block splitting to allow the video decoding apparatus to split the block equally to the video encoding apparatus. Further, the entropy encoder 155 encodes information on a prediction type indicating whether the current block is encoded by intra prediction or inter prediction. The entropy encoder 155 encodes intra prediction information (i.e., information on an intra prediction mode) or inter prediction information (in the case of the merge mode, a merge index and in the case of the AMVP mode, information on the reference picture index and the motion vector difference) according to the prediction type. Further, the entropy encoder 155 encodes information related to quantization, i.e., information on the quantization parameter and information on the quantization matrix.

The inverse quantizer 160 dequantizes the quantized transform coefficients output from the quantizer 145 to generate the transform coefficients. The inverse transformer 165 transforms the transform coefficients output from the inverse quantizer 160 into a spatial domain from a frequency domain to reconstruct the residual block.

The adder 170 adds the reconstructed residual block and the prediction block generated by the predictor 120 to reconstruct the current block. Pixels in the reconstructed current block may be used as reference pixels when intra-predicting a next-order block.

The loop filter unit 180 performs filtering for the reconstructed pixels in order to reduce blocking artifacts, ringing artifacts, blurring artifacts, etc., which occur due to block based prediction and transform/quantization. The loop filter unit 180 as an in-loop filter may include all or some of a deblocking filter 182, a sample adaptive offset (SAO) filter 184, and an adaptive loop filter (ALF) 186.

The deblocking filter 182 filters a boundary between the reconstructed blocks in order to remove a blocking artifact, which occurs due to block unit encoding/decoding, and the SAO filter 184 and the ALF 186 perform additional filtering for a deblocked filtered video. The SAO filter 184 and the ALF 186 are filters used for compensating differences between the reconstructed pixels and original pixels, which occur due to lossy coding. The SAO filter 184 applies an offset as a CTU unit to enhance a subjective image quality and encoding efficiency. On the other hand, the ALF 186 performs block unit filtering and compensates distortion by applying different filters by dividing a boundary of the corresponding block and a degree of a change amount. Information on filter coefficients to be used for the ALF may be encoded and signaled to the video decoding apparatus.

The reconstructed block filtered through the deblocking filter 182, the SAO filter 184, and the ALF 186 is stored in the memory 190. When all blocks in one picture are reconstructed, the reconstructed picture may be used as a reference picture for inter predicting a block within a picture to be encoded afterwards.

The video encoding device may store a bitstream of encoded video data in a non-transitory storage medium or transmit the bitstream to the video decoding device through a communication network.

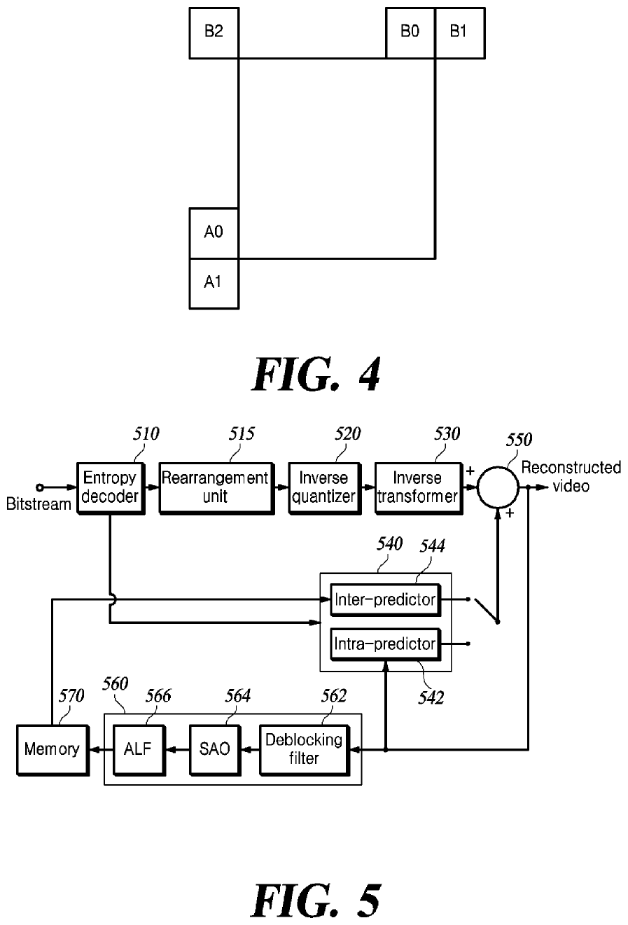

FIG. 5 is a functional block diagram of a video decoding apparatus that may implement the technologies of the present disclosure. Hereinafter, referring to FIG. 5, the video decoding apparatus and components of the apparatus are described.

The video decoding apparatus may include an entropy decoder 510, a rearrangement unit 515, an inverse quantizer 520, an inverse transformer 530, a predictor 540, an adder 550, a loop filter unit 560, and a memory 570.

Similar to the video encoding apparatus of FIG. 1, each component of the video decoding apparatus may be implemented as hardware or software or implemented as a combination of hardware and software. Further, a function of each component may be implemented as the software, and a microprocessor may also be implemented to execute the function of the software corresponding to each component.

The entropy decoder 510 extracts information related to block splitting by decoding the bitstream generated by the video encoding apparatus to determine a current block to be decoded and extracts prediction information required for reconstructing the current block and information on the residual signals.

The entropy decoder 510 determines the size of the CTU by extracting information on the CTU size from a sequence parameter set (SPS) or a picture parameter set (PPS) and splits the picture into CTUs having the determined size. In addition, the CTU is determined as a highest layer of the tree structure, i.e., a root node, and split information for the CTU may be extracted to split the CTU by using the tree structure.

For example, when the CTU is split by using the QTBTTT structure, a first flag (QT_split_flag) related to splitting of the QT is first extracted to split each node into four nodes of the lower layer. In addition, a second flag (mtt_split_flag), a split direction (vertical/horizontal), and/or a split type (binary/ternary) related to splitting of the MTT are extracted with respect to the node corresponding to the leaf node of the QT to split the corresponding leaf node into an MTT structure. As a result, each of the nodes below the leaf node of the QT is recursively split into the BT or TT structure.

As another example, when the CTU is split by using the QTBTTT structure, a CU split flag (split_cu_flag) indicating whether the CU is split is extracted. When the corresponding block is split, the first flag (QT_split_flag) may also be extracted. During a splitting process, with respect to each node, recursive MTT splitting of 0 times or more may occur after recursive QT splitting of 0 times or more. For example, with respect to the CTU, the MTT splitting may immediately occur, or on the contrary, only QT splitting of multiple times may also occur.

As another example, when the CTU is split by using the QTBT structure, the first flag (QT_split_flag) related to the splitting of the QT is extracted to split each node into four nodes of the lower layer. In addition, a split flag (split_flag) indicating whether the node corresponding to the leaf node of the QT is further split into the BT, and split direction information are extracted.

Meanwhile, when the entropy decoder 510 determines a current block to be decoded by using the splitting of the tree structure, the entropy decoder 510 extracts information on a prediction type indicating whether the current block is intra predicted or inter predicted. When the prediction type information indicates the intra prediction, the entropy decoder 510 extracts a syntax element for intra prediction information (intra prediction mode) of the current block. When the prediction type information indicates the inter prediction, the entropy decoder 510 extracts information representing a syntax element for inter prediction information, i.e., a motion vector and a reference picture to which the motion vector refers.

Further, the entropy decoder 510 extracts quantization related information and extracts information on the quantized transform coefficients of the current block as the information on the residual signals.

The rearrangement unit 515 may change a sequence of 1D quantized transform coefficients entropy-decoded by the entropy decoder 510 to a 2D coefficient array (i.e., block) again in a reverse order to the coefficient scanning order performed by the video encoding apparatus.

The inverse quantizer 520 dequantizes the quantized transform coefficients and dequantizes the quantized transform coefficients by using the quantization parameter. The inverse quantizer 520 may also apply different quantization coefficients (scaling values) to the quantized transform coefficients arranged in 2D. The inverse quantizer 520 may perform dequantization by applying a matrix of the quantization coefficients (scaling values) from the video encoding apparatus to a 2D array of the quantized transform coefficients.

The inverse transformer 530 generates the residual block for the current block by reconstructing the residual signals by inversely transforming the dequantized transform coefficients into the spatial domain from the frequency domain.

Further, when the inverse transformer 530 inversely transforms a partial area (subblock) of the transform block, the inverse transformer 530 extracts a flag (cu_sbt_flag) that only the subblock of the transform block is transformed, directional (vertical/horizontal) information (cu_sbt_horizontal_flag) of the subblock, and/or positional information (cu_sbt_pos_flag) of the subblock. The inverse transformer 530 also inversely transforms the transform coefficients of the corresponding subblock into the spatial domain from the frequency domain to reconstruct the residual signals and fills an area, which is not inversely transformed, with a value of “0” as the residual signals to generate a final residual block for the current block.

Further, when the MTS is applied, the inverse transformer 530 determines the transform function or the transform matrix to be applied in each of the horizontal and vertical directions by using the MTS information (mts_idx) signaled from the video encoding apparatus. The inverse transformer 530 also performs inverse transform for the transform coefficients in the transform block in the horizontal and vertical directions by using the determined transform function.

The predictor 540 may include an intra predictor 542 and an inter predictor 544. The intra predictor 542 is activated when the prediction type of the current block is the intra prediction, and the inter predictor 544 is activated when the prediction type of the current block is the inter prediction.

The intra predictor 542 determines the intra prediction mode of the current block among the plurality of intra prediction modes from the syntax element for the intra prediction mode extracted from the entropy decoder 510. The intra predictor 542 also predicts the current block by using neighboring reference pixels of the current block according to the intra prediction mode.

The inter predictor 544 determines the motion vector of the current block and the reference picture to which the motion vector refers by using the syntax element for the inter prediction mode extracted from the entropy decoder 510.

The adder 550 reconstructs the current block by adding the residual block output from the inverse transformer 530 and the prediction block output from the inter predictor 544 or the intra predictor 542. Pixels within the reconstructed current block are used as a reference pixel upon intra predicting a block to be decoded afterwards.

The loop filter unit 560 as an in-loop filter may include a deblocking filter 562, an SAO filter 564, and an ALF 566. The deblocking filter 562 performs deblocking filtering a boundary between the reconstructed blocks in order to remove the blocking artifact, which occurs due to block unit decoding. The SAO filter 564 and the ALF 566 perform additional filtering for the reconstructed block after the deblocking filtering in order to compensate differences between the reconstructed pixels and original pixels, which occur due to lossy coding. The filter coefficients of the ALF are determined by using information on filter coefficients decoded from the bitstream.

The reconstructed block filtered through the deblocking filter 562, the SAO filter 564, and the ALF 566 is stored in the memory 570. When all blocks in one picture are reconstructed, the reconstructed picture may be used as a reference picture for inter predicting a block within a picture to be encoded afterwards.

The present disclosure in some embodiments relates to encoding and decoding video images as described above. More specifically, the present disclosure provides a video coding method and an apparatus that effectively transmit information about an affine model when predicting the current block based on the affine model.

The following embodiments may be performed by the inter predictor 124 in the video encoding device. The following embodiments may also be performed by inter predictor 544 in the video decoding device.

The video encoding device in encoding the current block may generate signaling information associated with the present embodiments in terms of optimizing rate distortion. The video encoding device may use the entropy encoder 155 to encode the signaling information and transmit the encoded signaling information to the video decoding device. The video decoding device may use the entropy decoder 510 to decode, from the bitstream, the signaling information associated with the decoding of the current block.

In the following description, the term “target block” may be used interchangeably with the current block or coding unit (CU), or may refer to some area of a coding unit.

Further, the value of one flag being true indicates when the flag is set to 1. Additionally, the value of one flag being false indicates when the flag is set to 0.

### I. Affine Model-based Prediction

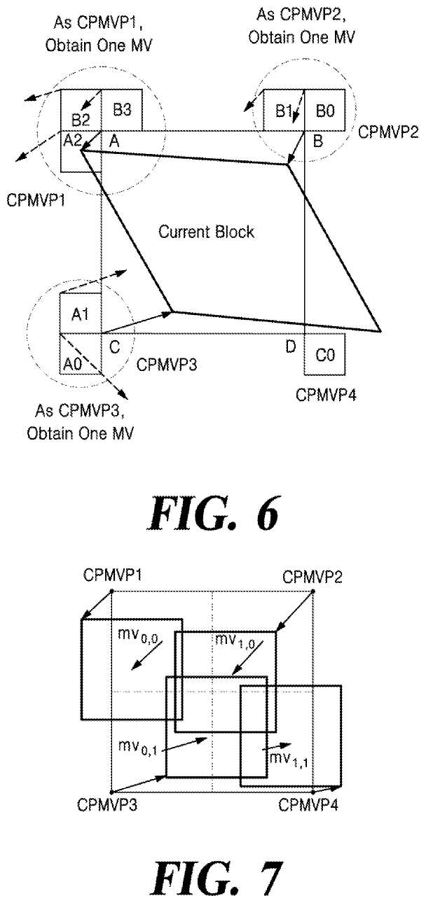

FIG. 6 is a diagram illustrating the pixel-wise calculation of an affine model, according to at least one embodiment of the present disclosure.

The embodiment of FIG. 6 uses the possible sameness or similarity of the pixel values and motion information between the current block and neighboring blocks. The video decoding apparatus uses the motion vector of a neighboring block of a position corresponding to a vertex (A, B, C) of the current block to predict a corresponding control point motion vector (CPMV). The video decoding apparatus uses control point motion vectors to model, between the current block and the prediction block, a geometric transform relationship, i.e., an affine model, and then performs a prediction of the current block based on the modeled transformation relationship. FIG. 6 illustrates a 6-parameter model using control point motion vectors at three control points A, B, and C, but some embodiments may employ a 4-parameter model using control point motion vectors at two control points A and B, or A and C. According to the 4-parameter model and the 6-parameter model, the motion vector (mvₓ, mv_{y}) at the target block (x,y) pixel may be expressed as shown in Equation 1 and Equation 2, respectively, by using the control point motion vector and each pixel's position.

$$\{ \begin{matrix}{mv}_{x} = \frac{{cpmv}_{2 x} - {cpmv}_{1 x}}{W} x - \frac{{cpmv}_{2 y} - {cpmv}_{1 y}}{W} y + {cpmv}_{1 x} \\ {mv}_{y} = \frac{{cpmv}_{2 y} - {cpmv}_{1 y}}{W} x + \frac{{cpmv}_{2 x} - {cpmv}_{1 x}}{W} y + {cpmv}_{1 y}\end{matrix} \qquad [ Equation 1 ]$$

$$\{ \begin{matrix}{mv}_{x} = \frac{{cpmv}_{2 x} - {cpmv}_{1 x}}{W} x + \frac{{cpmv}_{3 x} - {cpmv}_{1 x}}{H} y + {cpmv}_{1 x} \\ {mv}_{y} = \frac{{cpmv}_{2 y} - {cpmv}_{1 y}}{W} x + \frac{{cpmv}_{3 y} - {cpmv}_{1 y}}{H} y + {cpmv}_{1 y}\end{matrix} \qquad [ Equation 2 ]$$

Here, W and H represent the width and height of the current block. (cpmvᵢₓ, cpmv_{iy}) represents the i-th control point motion vector. The prediction value for each pixel of the current block may be predicted by using the motion vector calculated according to Equation 1 or Equation 2. Although not included in the affine model, a CPMVP4 may be defined for position D, as shown in the example of FIG. 6. Since position D is a pixel that has not yet been reconstructed, the embodiment may use the motion vector of a co-located pixel in the reference picture for the CPMVP4.

In the example of FIG. 6, CPMVP represents a control point motion vector predictor in affine AMVP mode (affine advanced motion vector prediction mode). In affine merge mode, the motion vector difference (MVD) is not transmitted, so CPMVP is the same as CPMV (control point motion vector). In the affine AMVP mode, the motion vector difference is transmitted, so the CPMV may be calculated by summing the CPMVP and MVD. The example in FIG. 6 shows a method of generating a control point motion vector predictor in affine AMVP mode that uses a construction. The affine merge mode and the affine AMVP mode are described below.

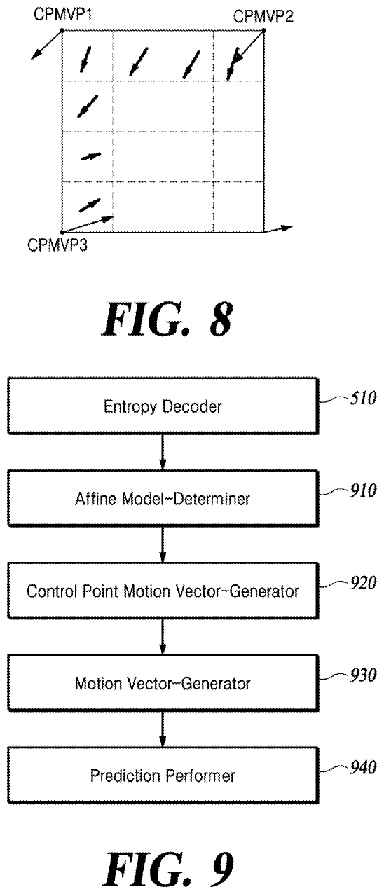

FIG. 7 is a diagram illustrating the affine model calculation using a center vector, according to at least one embodiment of the present disclosure.

Further, to reduce computational complexity in some embodiments, the video decoding apparatus may perform block-wise prediction by using each control point motion vector as a center vector, as illustrated in FIG. 7. At this time, by assuming that the current block has four control point motion vectors, the current block may be split into four blocks. In the method illustrated in FIG. 7, the block with each control point motion vector as the center vector may be predicted according to a common motion vector. This can reduce the computational complexity, although its prediction accuracy may be lower compared to the embodiment that performs a pixel-wise calculation.

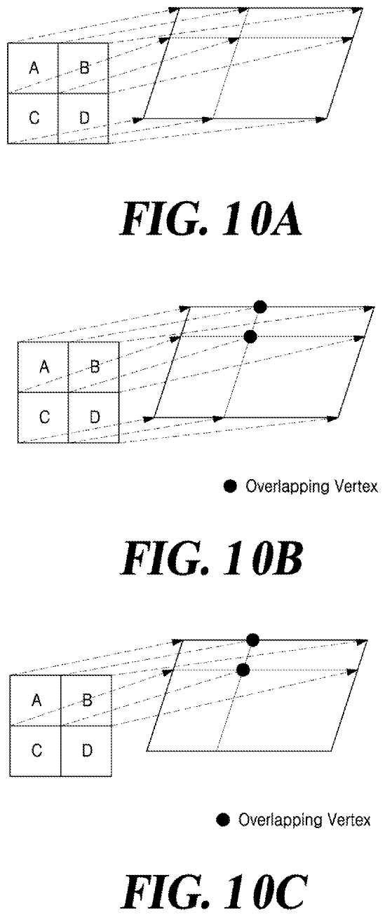

FIG. 8 is a diagram illustrating the subblock-wise computation of an affine model, according to at least one embodiment of the present disclosure.

In another embodiment, to reduce computational complexity, the video decoding apparatus may perform the subblock-wise prediction on each subblock, as illustrated in FIG. 8. The video decoding apparatus may split the current block into subblocks if the horizontal or vertical dimensions of the current block are larger than those of the subblocks. The video decoding apparatus may derive a control point motion vector at each vertex position of the split subblock by using the control point motion vectors of the current block, and then derive a representative motion vector of the control point motion vectors of each subblock. The video decoding apparatus generates a prediction block in subblock units by using the derived representative motion vector and then combines the subblock-wise prediction blocks to generate the first prediction block of the current block.

In some embodiments, the video decoding apparatus may subject the first prediction block to filtering to generate the second prediction block. The video decoding apparatus may then generate a final prediction block of the current block by using one of the first prediction block and the second prediction block.

To reduce the number of bits required for encoding the control point motion vectors, some embodiments may employ the regular inter prediction (translational motion prediction) method as described above, namely, the affine merge mode and the affine AMVP mode. Hereinafter, the affine merge mode and the affine AMVP mode are referred to as the control point motion vector prediction method.

As an example, in the affine merge mode, the inter predictor 124 of the video encoding apparatus composes a list of predefined numbers (e.g., 5) of affine merge candidates. First, the video encoding apparatus derives inherited affine merge candidates from the neighbor blocks of the target block. For example, the video encoding apparatus generates a merge candidate list by deriving a predefined number of inherited affine merge candidates from the neighboring samples (A0, A1, B0, B1, B2) of the target block shown in FIG. 4. Each of the inherited affine merge candidates included in the candidate list corresponds to a combination of two or three CPMVs.

The video encoding apparatus derives the inherited affine merge candidates from control point motion vectors of the neighbor blocks of the target block, which are predicted in affine mode. Some embodiments may limit the number of merge candidates derived from neighbor blocks predicted in affine mode. For example, the video encoding apparatus may derive, from the neighbor blocks predicted in affine mode, two inherited affine merge candidates of one of A0 and A1 plus one of B0, B1, and B2. The priorities may be in the order of A0, A1, and then B0, B1, and B2.

Meanwhile, if the total number of merge candidates is three or more, the video encoding apparatus may additionally derive an insufficient number of constructed affine merge candidates from the translational motion vectors of the neighbor blocks, as shown in the example of FIG. 6.

The video encoding apparatus derives control point motion vectors CPMV1, CPMV2, and CPMV3, one each from neighbor block group {B2, B3, A2}, neighbor block group {B1, B0}, and neighbor block group {A1, A0}. As one example, the priorities within each neighbor block group may be in the order of B2, B3, A2, order of B1, B0, and order of A1, A0. Further, the video encoding apparatus derives another control point motion vector CPMV4 from the co-located block CO in the reference picture. The video encoding apparatus combines two or three of the four control point motion vectors to additionally generate an insufficient number of constructed affine merge candidates. The combinations are prioritized as follows. The elements within each group are listed in the following order: top-left, top-right, and bottom-left control point motion vectors. {CPMV1, CPMV2, CPMV3}, {CPMV1, CPMV2, CPMV4}, {CPMV1, CPMV3, CPMV4}, {CPMV2, CPMV3, CPMV4}, {CPMV1, CPMV2}, {CPMV1, CPMV3}

If the merge candidate list cannot be filled up by using the inherited affine merge candidates and the constructed affine merge candidates, the video encoding apparatus may add zero motion vectors as candidates.

The video encoding apparatus selects a merge candidate from the merge candidate list in terms of optimizing coding efficiency and determines a merge index indicative of the selected merge candidate. The video encoding apparatus performs an affine motion prediction for the target block by using the selected merge candidate. If the merge candidate is composed of two control point motion vectors, an affine motion prediction is performed by using a 4-parameter model. On the other hand, if the merge candidate is composed of three control point motion vectors, an affine motion prediction is performed by using a 6-parameter model. The video encoding apparatus encodes the merge index and signals the encoded merge index to the video decoding apparatus.

The video decoding apparatus decodes the merge index. The inter predictor 544 of the video decoding apparatus composes the merge candidate list in the same manner as the video encoding apparatus and performs an affine motion prediction by using control point motion vectors corresponding to the merge candidate indicated by the merge index.

As another example, in the affine AMVP mode, in terms of optimizing coding efficiency, the inter predictor 124 of the video encoding apparatus determines the form of the affine model for the target block and its accompanied actual control point motion vectors. For each control point, the video encoding apparatus calculates the MVD (motion vector difference), which is the difference between the actual control point motion vector and each control point motion vector predictor (MVP of each control point), and then encodes the MVD of each control point. To derive each control point motion vector predictor, the inter predictor 124 composes a list of predefined numbers (e.g., 2) of affine AMVP candidates. If the target block is of the 4-parameter type, the candidates included in the list are each composed of a pair of two control point motion vectors. On the other hand, if the target block is of the 6-parameter type, the candidates in the list are each composed of a set of three control point motion vectors.

The following describes a method of composing a candidate list in affine AMVP mode. The affine AMVP candidate list may be derived similarly to the method of composing the affine merge candidate list described above.

The video encoding apparatus checks whether the reference picture of the inherited affine AMVP candidate is the same as the reference picture of the current block. Here, the inherited affine AMVP candidate may be a block that is predicted in affine mode among the neighbor blocks (A0, A1, B0, B1, B2) of the target block shown in FIG. 4, as in the aforementioned affine merge mode.

If the reference picture of the inherited affine AMVP candidate is the same as the reference picture of the current block, the video encoding apparatus adds the corresponding inherited affine AMVP candidate.

On the other hand, if the reference picture of the inherited affine AMVP candidate is different from the reference picture of the current block, the video encoding apparatus checks whether the reference picture of all CPMVs of the constructed affine AMVP candidate is the same as the reference picture of the current block. Here, all CPMVPs of the constructed affine AMVP candidate may be derived from the motion vectors of the neighboring samples shown in FIG. 6, as in the affine merge mode described above. If the reference picture of all CPMVPs of the constructed affine AMVP candidate is the same as the reference picture of the current block, the video encoding apparatus adds the corresponding constructed affine AMVP candidate.

At this point, the affine model form of the target block needs to be considered. The video encoding apparatus sees if the affine model of the target block is of the 4-parameter type and, when positive, derive two control point motion vectors, i.e, the top-left and top-right control point motion vectors of the target block by using the affine model of the neighbor block. If the affine model of the target block is of the 6-parameter type, the video encoding apparatus uses the affine model of the neighbor block to derive three control point motion vectors, i.e., the top-left, top-right, and bottom-left control point motion vectors of the target block.

If the reference picture of all CPMVPs is different from the reference picture of the current block, the video encoding apparatus adds a translational motion vector as an affine AMVP candidate.

If the candidate list cannot be filled up, i.e., the preset number of candidates is not fulfilled even with all the above steps, the video encoding apparatus shall add zero motion vectors for affine AMVP candidates.

The video encoding apparatus selects one candidate from the affine AMVP list and determines a candidate index that indicates the selected candidate. At this time, each of the control point motion vectors of the selected candidate corresponds to each of the control point motion vector predictors. In terms of optimizing coding efficiency, the video encoding apparatus determines an actual control point motion vector for each control point in the target block and then calculates an MVD between the actual control point motion vector and the control point motion vector predictor. The video encoding apparatus encodes the affine model form of the target block, the candidate index, and the MVD of each control point and signals the encoded affine model form of the target block, the encoded candidate index, and encoded the MVD of each control point to the video decoding apparatus.

The video decoding apparatus decodes the affine model form, the candidate index, and the MVD of each control point. The inter predictor 544 of the video decoding apparatus generates the affine AMVP list in the same manner as the video encoding apparatus and selects a candidate indicated by the candidate index from the affine AMVP list. The video decoding apparatus sums each control point motion vector predictor of the selected candidate and the corresponding MVD to reconstruct the motion vector of each control point. The video decoding apparatus uses the reconstructed control point motion vectors to perform the affine motion prediction.

The following embodiments are described with reference to the video decoding apparatus, but they may be implemented in the same or similar manner by the video encoding apparatus.

### II. Embodiments According to the Present Disclosure

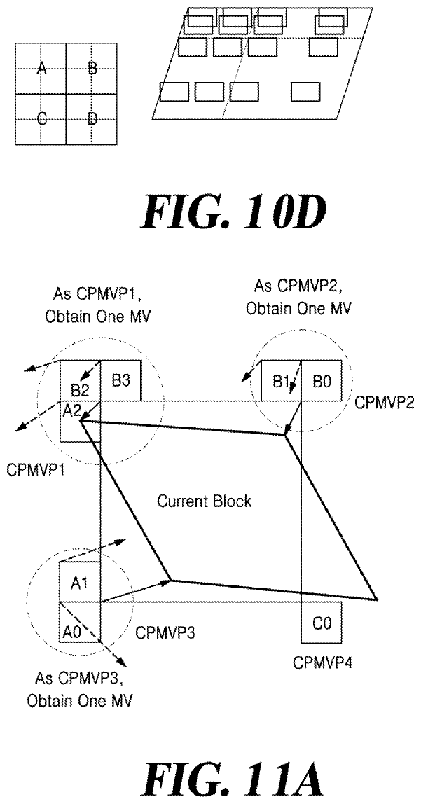

FIG. 9 is a diagram illustrating a portion of the video decoding apparatus for affine model-based prediction, according to at least one embodiment of the present disclosure.

The video decoding apparatus according to some embodiments of the present disclosure may determine an affine model, perform a prediction of the current block based on the determined affine model, and finally generate a reconstructed block of the current block. What is illustrated in FIG. 9 may be performed by the entropy decoder 510, the inter predictor 544, and the adder 550 of the video decoding apparatus. Meanwhile, the same operations as illustrated in FIG. 9 may be performed by the picture splitter 110, the predictor 120, and the adder 170 of the video encoding apparatus. In this case, the video decoding apparatus may use encoding information parsed from a bitstream, while the video encoding apparatus may use encoding information set at a higher level in terms of minimizing a rate distortion. Hereinafter, for convenience of description, embodiments are described centering on the video decoding apparatus.

As illustrated in FIG. 9, the inter predictor 544 may include all or part of an affine model-determiner 910, a control point motion vector-generator 920, a motion vector-generator 930, and a prediction performer 940.

In some embodiments, the video encoding apparatus transmits all or part of an affine model application flag, information on the affine model, information on the control point motion vector, and the residual block. Here, the affine model application flag indicates whether the current block is a prediction block based on the affine model-based prediction.

The entropy decoder 510 may decode, from the bitstream transmitted by the video encoding apparatus, all or part of the affine model application flag, the affine model information, information on the control point motion vector prediction method, the residual block, and the reference picture index.

The affine model application flag indicates whether the current block is a block predicted by the affine model-based prediction. The affine prediction model information indicates the form of the affine model, i.e., whether it is a 4-parameter model or a 6-parameter model. The control point motion vector information includes information on the control point motion vectors that depend on the affine model, such as the number of control point motion vectors, a control point motion vector prediction method, a control point motion vector difference value, and the like. Here, the control point motion vector prediction method may be an affine merge mode or an affine AMVP mode.

If the affine model application flag about the affine model-based prediction is true, the affine model-determiner 910 may use the affine model information as a basis for determining the form of the affine model to derive the number of control point motion vectors.

The control point motion vector-generator 920 predicts a control point motion vector for the current block. Based on the relevant syntax and the prediction mode information of the decoded neighbor blocks of the current block, the control point motion vector-generator 920 determines the number of control point motion vectors in the current block and generates the respective control point motion vector predictors. Here, the relevant syntax includes the control point motion vector prediction method, the reference picture index, and the like.

After generating the control point motion vector predictor, the control point motion vector-generator 920 adds the control point motion vector difference to the control point motion vector predictor, thereby calculating the control point motion vector. If the control point motion vector of the affine model has been transmitted in the affine merge mode, the process of adding the control point motion vector difference to the control point motion vector predictor may be omitted. Here, the affine merge mode refers to a method of determining the control point motion vector in the same manner as with the neighboring vectors without motion vector difference.

The motion vector-generator 930 calculates the motion vector by using the control point motion vector in the unit used for the current block in calculating its motion vector. For example, if a subblock is a unit for calculating the motion vector, the motion vector may be calculated in a subblock unit.

The prediction performer 940 may perform interpolation filtering on the reference block according to the accuracy of the motion vector. The prediction performer 940 may perform motion prediction compensation by using the motion vector to generate a prediction block of the current block. Then, the prediction performer 940 may sum the prediction block and the decoded residual block to generate a reconstructed block of the current block.

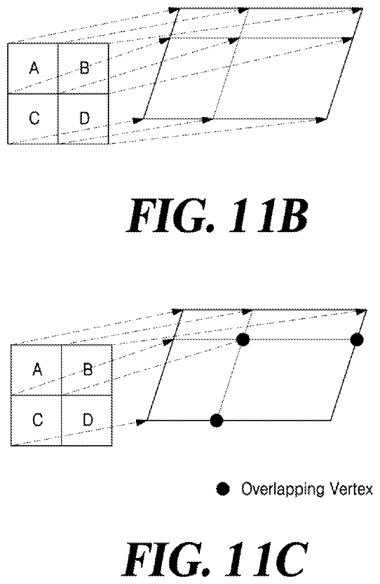

FIGS. 10A to 10D are diagrams illustrating motion vectors of subblock units according to at least one embodiment of the present disclosure.

In one example, with subblocks of size 4×4, the target blocks A, B, C, and D of size 8×8 have a geometric relationship established with a reference block, as illustrated by dashed arrows in FIG. 10A. To perform decoding based on the right affine model, a 6-parameter model-based decoding needs corresponding vector information to the dotted arrows in FIG. 10B and a 4-parameter model-based decoding needs corresponding vector information to the dotted arrows in FIG. 10C. Further, motion vectors of subblock units calculated based on the corresponding vector information may be conceptualized as in the example of FIG. 10D.

In the examples of FIGS. 10B and 10C, some of the control point motion vectors of blocks A, B, C, and D, as at enlarged vertexes, may overlap with each other. Namely, if the geometric relationship is continuous from block to block, overlapping information may occur. Therefore, if affine model information is transmitted separately for each of blocks A, B, C, and D, retransmitting of overlapping information would occur. Here, the overlapping information may be, for example, a control point motion vector which may include a control point motion vector predictor and/or a control point motion vector difference. At the overlapping vertex, by using the overlapping information of the reconstructed block, the video decoding apparatus may derive the current block's control point motion vector, i.e., control point motion vector predictor or control point motion vector difference.

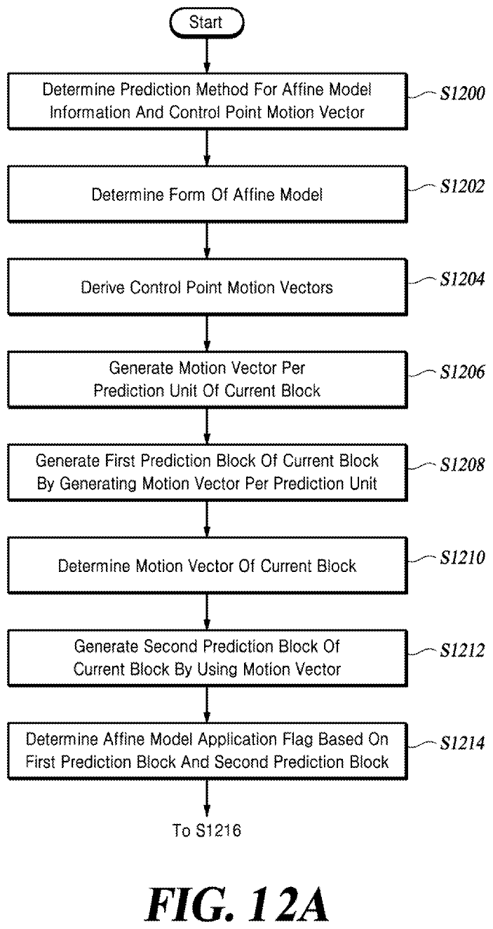

FIGS. 11A to IC are diagrams illustrating a derivation of an overlapping control point motion vector according to at least one embodiment of the present disclosure.

When a target block has four control point motion vectors defined as in the example of FIG. 11A, four target blocks A, B, C, and D may have control point motion vectors defined as illustrated by the dashed arrows in FIG. 11B.

In one example, the video decoding apparatus performs an affine model-based prediction by using the overlapping control point motion vectors derived from the control point motion vectors of the reconstructed blocks, by using the derived control point motion vector without additional transmission of the motion vector difference (MVD). According to the decoding sequence, affine model-based decoding may be performed on A block followed by affine model-based decoding on B block. When, under the application of affine AMVP, the MVD of CPMVP1 of B block is parsed as 0 and CPMVP3 of B block is predicted from the motion vector of A block or a subblock of A block, the video decoding apparatus may omit to transmit the MVD of CPMVP3 of B block.

Thereafter, affine model-based prediction may be applied to A block and B block followed by affine model-based prediction on C block. When, under the application of the affine AMVP, the MVD of CPMVP1 of C block is 0 and the MVD of CPMVP3 of B block is omitted or 0, the video decoding apparatus may omit to transmit the MVD of CPMVP2 of C block.

Thereafter, affine model-based prediction may be applied to all of the A, B, and C blocks followed by affine model-based prediction on D block. When the MVD of CPMVP3 of B block is omitted or 0 and the MVD of CPMVP2 of C block is 0 or omitted, the video decoding apparatus may omit to transmit MVDs of the D block's control point motion vectors altogether. For example, when the MVD of CPMVP3 of B block is omitted or 0 and CPMVP2 of D block is predicted from the motion vector of B block or a subblock of B block, the transmission of the MVD for CPMVP3 of block D may be omitted. Additionally, if the MVD of CPMVP2 of block C is omitted or zero, and CPMVP3 of block D is the motion vector of block C (or, a subblock of block C), the video decoding apparatus may omit to transmit the MVD of CPMVP2 of D block.

In sum, the present disclosure can omit transmission of the MVD corresponding to the CPMVP at an overlapping vertex in the target block when the target block is predicted according to the affine AMVP mode, the MVD of the CPMVP at the overlapping vertex in the reconstructed block is omitted or 0, and the CPMVP in the target block is predicted from the motion vector of the reconstructed block or a subblock of the reconstructed block based on the overlapping vertex. Here, the second condition that the MVD of the CPMVP at the overlapping vertex in the reconstructed block is omitted indicates that the reconstructed block is predicted according to the affine merge mode. The alternative condition that the MVD of the CPMVP at the overlapping vertex in the reconstructed block is 0 indicates that the reconstructed block is predicted according to the affine AMVP mode and the MVD of the CPMVP at the overlapping vertex is 0.

The enlarged vertexes illustrated in FIG. 1C represent vertices where transmission of the MVD may be omitted, based on the overlapping as described above.

In some embodiments, weights may be further transmitted for calculating the motion vector of a subblock within the current block. The video decoding apparatus may use a weight w to scale the motion vectors of the subblocks that are calculated based on the respective control point motion vectors.

For example, for the 4-parameter model, the subblock motion vector may be predicted as shown in Equation 3.

$$[ Equation 3 ]$$

$$\{ \begin{matrix}{mv}_{x} = \frac{{w}_{2 x} {cpmv}_{2 x} - {w}_{1 x} {cpmv}_{1 x}}{W} x - \frac{{w}_{2 y} {cpmv}_{2 y} - {w}_{1 y} {cpmv}_{1 y}}{W} y + {cpmv}_{1 x} \\ {mv}_{y} = \frac{{w}_{2 y} {cpmv}_{2 y} - {w}_{1 y} {cpmv}_{1 y}}{W} x + \frac{{w}_{2 x} {cpmv}_{2 x} - {w}_{1 x} {cpmv}_{1 x}}{W} y + {cpmv}_{1 y}\end{matrix}$$

Here, w₂ₓ+w₁ₓ=1, so only one of w₁ₓ and w₂ₓ may be transmitted and the other may be derived. Additionally, since w_{2y}+w_{1y}=1, only one of w_{1y} and w_{2y} may be transmitted and the other may be derived.

Further, for the 6-parameter model, the subblock motion vector may be predicted as shown in Equation 4.

$$[ Equation 4 ]$$

$$\{ \begin{matrix}{mv}_{x} = \frac{{w}_{2 x} {cpmv}_{2 x} - {w}_{1 x} {cpmv}_{1 x}}{W} x + \frac{{w}_{3 x} {cpmv}_{3 x} - {w}_{1 x} {cpmv}_{1 x}}{H} y + {cpmv}_{1 x} \\ {mv}_{y} = \frac{{w}_{2 y} {cpmv}_{2 y} - {w}_{1 y} {cpmv}_{1 y}}{W} x + \frac{{w}_{3 y} {cpmv}_{3 y} - {w}_{1 y} {cpmv}_{1 y}}{H} y + {cpmv}_{1 y}\end{matrix}$$

As another example, for efficiency in the transmission of the weights, the current block may be weighted if the size of the current block is at least N times wider and at least M times longer horizontally or vertically than the size of the subblock for which the motion vector is calculated in the affine model-based prediction, where N and M are integers greater than or equal to 2. For example, there may be a subblock of size 4×4 for which the motion vector is computed. The current block may has an area of more than 16 times that of the subblock, and if the weight w is transmitted when the current block is split into two or more subblocks in the horizontal and vertical directions, the minimum area of the current block may be 16×16, 32×8, or 8×32.

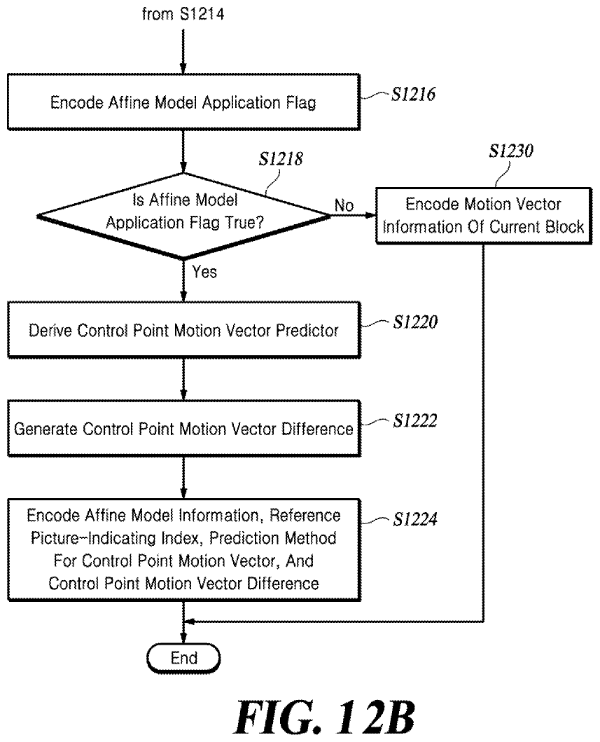

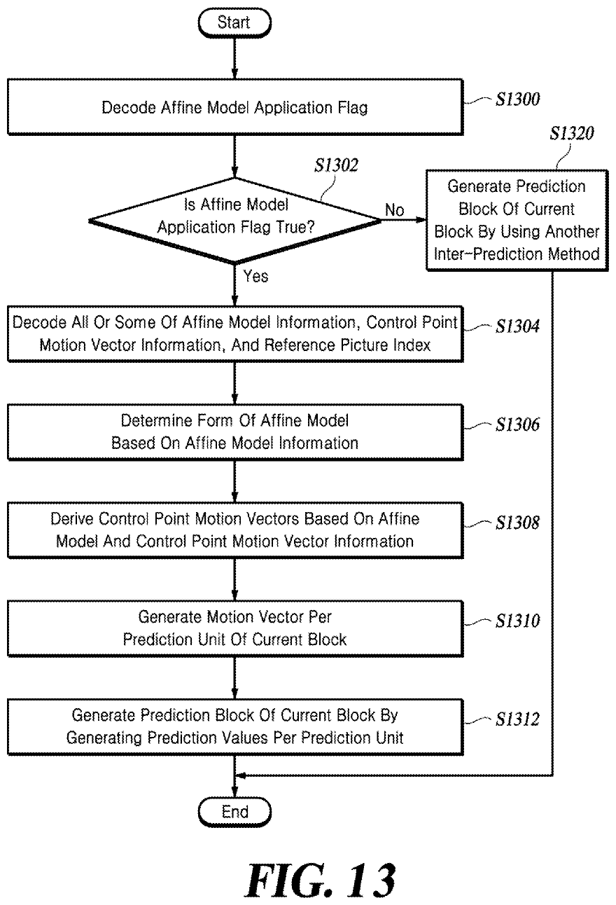

Referring now to FIGS. 12A, 12B, and FIG. 13, a method of predicting the current block based on an affine model is described.

FIGS. 12A and 12B are a flowchart of a method of encoding the current block by the video encoding apparatus, according to at least one embodiment of the present disclosure.

The video encoding apparatus determines affine model information and a prediction method for a control point motion vector (S1200). Here, the affine model information refers to the form of the affine model, i.e., whether it is a 4-parameter or 6-parameter model. The control point motion vector prediction method refers to the affine merge mode or the affine AMVP mode. The affine model information and the prediction method for the control point motion vector may be determined in terms of the rate-distortion optimization.

The video encoding apparatus determines the form of the affine model based on the affine model information (S1202).

The video encoding apparatus derives control point motion vectors based on the affine model (S1204).

The video encoding apparatus uses the control point motion vectors to generate the motion vector per prediction unit of current block (S1206). Here, the prediction unit may be a pixel, a block containing each control point motion vector, or a subblock within the current block.

The video encoding apparatus generates prediction values per prediction unit by using the motion vector and reference picture and thereby generates a first prediction block of the current block (S1208).

The video encoding apparatus determines the motion vector of the current block by using the reference picture (S1210). The motion vector of the current block may be determined in terms of rate-distortion optimization.

The video encoding apparatus uses the motion vector to generate a second prediction block of the current block (S1212).

The video encoding apparatus determines an affine model application flag based on the first prediction block and the second prediction block (S1214). Here, the affine model application flag indicates whether the current block is to be predicted according to an affine model-based prediction. For example, if the first prediction block is optimal, the affine model application flag may be determined to be true. On the other hand, if the second prediction block is optimal, the affine model application flag may be determined to be false.

The video encoding apparatus encodes the affine model application flag (S1216).

The video encoding apparatus checks the affine model application flag (S1218).

If the affine model application flag is true (Yes in S1218), the video encoding apparatus performs the following steps.

The video encoding apparatus derives control point motion vector predictors according to the prediction method for the affine model and control point motion vector (S1220).

The video encoding apparatus subtracts each of the control point motion vector predictors from each of the control point motion vectors to generate a control point motion vector difference (S1222).

Meanwhile, at an overlapping vertex between the encoded block and the current block, the video encoding apparatus may utilize the control point motion vector at the overlapping vertex in the encoded block to derive a control point motion vector at the overlapping vertex in the current block. The control point motion vector may include a control point motion vector predictor and/or a control point motion vector difference.

The video encoding apparatus encodes the affine model information, an index indicative of the reference picture, a prediction method for the control point motion vector, and the control point motion vector difference (S1224).

When the prediction method for the control point motion vector is the affine merge mode, the generation and encoding of the control point motion vector difference may be omitted.

Further, when the control point motion vector difference of the control point motion vector predictor at the overlapping vertex with the current block in the encoded block is omitted or 0 and the control point motion vector predictor at the overlapping vertex in the current block is predicted from the motion vector of the encoded block or a subblock of the encoded block based on the overlapping vertex, encoding of the control point motion vector difference corresponding to the control point motion vector predictor at the overlapping vertex in the current block may be omitted.

If the affine model application flag is false (No in S1218), the video encoding apparatus encodes the motion vector information of the current block (S1230). Here, the motion vector information may include the index indicative of the reference picture, the prediction method for the motion vector, e.g., merge mode or AMVP mode, a motion vector difference, and the like.

The video encoding apparatus may then subtract the prediction block from the original block of the current block to generate a residual block, and encode the generated residual block.

FIG. 13 is a flowchart of a method of reconstructing the current block by the video decoding apparatus, according to at least one embodiment of the present disclosure.

The video decoding apparatus decodes an affine model application flag from the bitstream (S1300). Here, the affine model application flag indicates whether the current block is to be predicted according to an affine model-based prediction.

The video decoding apparatus checks the affine model application flag (S1302).

If the affine model application flag is true (Yes in S1302), the video decoding apparatus takes the following steps.

The video decoding apparatus decodes all or part of affine model information, control point motion vector information, and a reference picture index from the bitstream (S1304). Here, the affine model information refers to the form of the affine model, i.e., whether it is a 4-parameter or 6-parameter model. The control point motion vector information includes the prediction method for a control point motion vector and control point motion vector differences. The prediction method for the control point motion vector refers to affine merge mode or affine AMVP mode.

At an overlapping vertex between the reconstructed block and the current block, the video decoding apparatus may utilize the control point motion vector at the overlapping vertex in the reconstructed block to derive a control point motion vector at the overlapping vertex in the current block. The control point motion vector may include a control point motion vector predictor and/or a control point motion vector difference.

For example, when the control point motion vector difference of the control point motion vector predictor at the overlapping vertex in the reconstructed block is omitted or 0 and the control point motion vector predictor at the overlapping vertex in the current block is predicted from the motion vector of the reconstructed block or a subblock of the reconstructed block based on the overlapping vertex, decoding of the control point motion vector difference corresponding to the control point motion vector predictor at the overlapping vertex in the current block may be omitted.

The video decoding apparatus determines a form of the affine model based on the affine model information (S1306).

The video decoding apparatus derives control point motion vectors based on the affine model and control point motion vector information (S1308).

The video decoding apparatus determines the number of control point motion vectors according to the affine model and generates each control point motion vector predictor based on the prediction method for the control point motion vector and the prediction mode information of the neighboring decoded blocks of the current block. The video decoding apparatus generates each control point motion vector by summing each control point motion vector predictor and the corresponding control point motion vector difference.

The video decoding apparatus generates the motion vector per prediction unit of current block by using the control point motion vectors (S1310). Here, the prediction unit may be a pixel, a block containing each control point motion vector, or a subblock within the current block.

The video decoding apparatus uses the motion vector and a reference picture indicated by the reference picture index to generate prediction values per prediction unit and thereby generate a prediction block of the current block (S1312).

If the affine model application flag is false (No in S1302), the video decoding apparatus generates the prediction block of the current block by using another inter-prediction method instead of performing the affine model-based prediction (S1320).

The video decoding apparatus may then sum the prediction block and the decoded residual block to generate a reconstructed block of the current block.

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in the present disclosure are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media, such as erasable programmable read-only memory (EPROM), flash drive, optical drive, magnetic hard drive, and solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which the present disclosure pertains should understand that the scope of the present disclosure should not be limited by the above explicitly described embodiments but by the claims and equivalents thereof.

### REFERENCE NUMERALS

124: inter predictor
544: inter predictor
920: control point motion vector-generator
930: motion vector-generator
940: prediction performer

### CROSS-REFERENCE TO RELATED APPLICATIONS

This application claims priority to and the benefit of Korean Patent Application No. 10-2022-0162308 filed on Nov. 29, 2022, and Korean Patent Application No. 10-2023-0135316, filed on Oct. 11, 2023, the entire contents of each of which are incorporated herein by reference.

1. A method of decoding a current block by a video decoding apparatus, the method comprising:
decoding, from a bitstream, all or part of affine model information, control point motion vector information, and a reference picture index, the affine model information indicating a form of an affine model, and the control point motion vector information including a prediction method for control point motion vectors and control point motion vector differences;
determining the form of the affine model based on the affine model information;
deriving control point motion vectors based on the affine model and the control point motion vector information;
generating a motion vector for each prediction unit of the current block by using the control point motion vectors; and
generating a prediction block of the current block by generating prediction values for each prediction unit of the current block by using the motion vector and a reference picture indicated by the reference picture index,
wherein decoding the control point motion vector information comprises:
deriving, at an overlapping vertex between a reconstructed block and the current block, a control point motion vector at the overlapping vertex in the current block by using a control point motion vector at the overlapping vertex in the reconstructed block.

2. The method of claim 1, further comprising:
decoding, from the bitstream, an affine model application flag that indicates whether the current block is to be predicted according to an affine model-based prediction; and
checking the affine model application flag,
wherein the method further comprises, when the affine model application flag is true: performing the affine model-based prediction.

3. The method of claim 1, wherein determining the form of the affine model comprises:
determining the affine model to be a 4-parameter model using two control point motion vectors, or a 6-parameter model using three control point motion vectors.

4. The method of claim 1, wherein deriving the control point motion vectors comprises:
determining a number of the control point motion vectors according to the affine model;
generating each control point motion vector predictor based on the prediction method and prediction mode information of neighboring decoded blocks of the current block; and
generating each of the control point motion vectors by summing each control point motion vector predictor and a corresponding control point motion vector difference.

5. The method of claim 1, wherein the prediction unit comprises:
a pixel, a block containing each control point motion vector, or a subblock within the current block.

6. The method of claim 5, wherein deriving the control point motion vectors comprises:
when the prediction method is in an affine merge mode, using each control point motion vector predictor for each of the control point motion vectors.

7. The method of claim 1, wherein decoding the control point motion vector information comprises:
responsive to a skipping or nulling of a control point motion vector difference of a control point motion vector predictor at an overlapping vertex in the reconstructed block, and to a prediction of a control point motion vector predictor at the overlapping vertex in the current block based on the overlapping vertex from a motion vector of the reconstructed block (or a subblock of the reconstructed block), skipping decoding of a control point motion vector difference corresponding to the control point motion vector predictor at the overlapping vertex in the current block.

8. The method of claim 1, further comprising:
decoding a weight from the bitstream, and
wherein generating the motion vector for each prediction unit comprises:
scaling the motion vector for each prediction unit by using the weight.

9. A method of encoding a current block by a video encoding apparatus, the method comprising:
determining affine model information and a prediction method for control point motion vectors, the affine model information indicating a form of an affine model;
determining the form of the affine model based on the affine model information;
deriving control point motion vectors based on the affine model;
generating a motion vector for each prediction unit of the current block by using the control point motion vectors;
generating a first prediction block of the current block by generating prediction values for each prediction unit by using the motion vector and a reference picture;
deriving control point motion vector predictors according to the affine model and the prediction method for the control point motion vectors, and generating a control point motion vector difference by subtracting each of the control point motion vector predictors from each of the control point motion vectors; and
encoding the affine model information, the index indicative of the reference picture, the prediction method for the control point motion vectors, and control point motion vector differences,
wherein generating the control point motion vector difference comprises:
deriving, at an overlapping vertex between an encoded block and the current block, a control point motion vector at the overlapping vertex in the current block by using a control point motion vector at the overlapping vertex in the encoded block.

10. The method of claim 9, further comprising:
determining a motion vector of the current block by using the reference picture; and
generating a second prediction block of the current block by using the motion vector.

11. The method of claim 10, further comprising:
determining, based on the first prediction block and the second prediction block, an affine model application flag that indicates whether the current block is to be predicted according to an affine model-based prediction; and
encoding the affine model application flag.

12. The method of claim 11, further comprising:
checking the affine model application flag,
wherein the method further comprises, when the affine model application flag is true:
proceeding with deriving the control point motion vector predictors through encoding the control point motion vector differences.

13. The method of claim 9, wherein encoding the control point motion vector difference comprises:
responsive to a skipping or nulling of a control point motion vector difference of a control point motion vector predictor at an overlapping vertex with the current block in the encoded block, and to a prediction of a control point motion vector predictor at the overlapping vertex in the current block based on the overlapping vertex from a motion vector of the encoded block (or a subblock of the encoded block), skipping encoding of a control point motion vector difference corresponding to the control point motion vector predictor at the overlapping vertex in the current block.

14. A computer-readable recording medium storing a bitstream generated by a video encoding method, the video encoding method comprises:
determining an affine model information and a prediction method for control point motion vectors, the affine model information indicating a form of an affine model;
determining the form of the affine model based on the affine model information;
deriving control point motion vectors based on the affine model;
generating a motion vector for each prediction unit of a current block by using the control point motion vectors;
generating a first prediction block of the current block by generating prediction values for each prediction unit by using the motion vector and a reference picture;
deriving control point motion vector predictors according to the affine model and the prediction method for the control point motion vector, and generating a control point motion vector difference by subtracting each of the control point motion vector predictors from each of the control point motion vectors; and
encoding the affine model information, the index indicative of the reference picture, the prediction method for the control point motion vectors, and control point motion vector differences,
wherein generating the control point motion vector difference comprises:
deriving, at an overlapping vertex between an encoded block and the current block, a control point motion vector at the overlapping vertex in the current block by using a control point motion vector at the overlapping vertex in the encoded block.
